(19) United States
(12) Patent Application Publication
(10) Pub. No.: US 2023/0045256 A1
(43) Pub. Date: Feb. 9, 2023

(54) COMPUTING DEVICE UPDATING

(71) Applicant: Ford Global Technologies, LLC, Dearborn, MI (US)

(72) Inventor: Maeen Yahia Mawari, Dearborn, MI (US)

(73) Assignee: Ford Global Technologies, LLC, Dearborn, MI (US)

(21) Appl. No.: 17/395,811

(22) Filed: Aug. 6, 2021

(51) Int. Cl. G06F 8/65

(52) U.S. Cl. CPC G06F 8/65

(57) ABSTRACT

Upon a computer receiving updated program instructions, an instruction is provided, via a gateway module, to a plurality of electronic control units (ECUs) to remove current program instructions from respective memories of the ECUs. Upon the computer receiving in response to the instruction a message from the gateway module that the current program instructions are removed from the ECUs' respective memories, the updated program instructions are provided, via the gateway module, to the ECUs. Upon receiving, at the computer, a message from the gateway module indicating that the updated program instructions are not stored in the respective memory of at least one of the ECUs, the updated program instructions are provided, via the gateway module, based on a number of received messages indicating that the updated program instructions are not stored in the respective memory of at least one of the ECUs being less than a threshold.

### BACKGROUND

Vehicles can be equipped with computers, networks, sensors, and/or controllers to acquire data regarding the vehicle's environment and/or to operate vehicle components. Vehicle sensors can provide data about a vehicle's environment, e.g., concerning routes to be traveled and objects in the vehicle's environment to be avoided. Various computers or controllers such as electronic control units (ECUs) can be provided in a vehicle and can communicate via a vehicle network. Messages sent and received via the vehicle network can relate to operating the vehicle, and can include sensor data, actuation commands, fault reports, etc. The computers typically may be programmed or reprogrammed via software updates, e.g., to add or replace an operation of the computer.

### BRIEF DESCRIPTION OF THE DRAWINGS

FIG. 1 is a block diagram for an example control system for a vehicle.

FIG. 2A is a block diagram illustrating an example instruction message.

FIG. 2B is a block diagram illustrating an example installation message.

FIG. 2C is a block diagram illustrating an example reinstallation message.

FIG. 2D is a block diagram illustrating an example request message.

FIG. 2E is a block diagram illustrating an example first update message.

FIG. 2F is a block diagram illustrating an example second update message.

FIG. 2G is a block diagram illustrating an example third update message.

FIG. 2H is a block diagram illustrating an example reply message.

FIG. 2I is a block diagram illustrating an example first status message.

FIG. 2J is a block diagram illustrating an example second status message.

FIG. 2K is a block diagram illustrating an example third status message.

FIG. 3 is a flowchart of an example process for updating, at a vehicle computer, program instructions for an electronic control unit (ECU).

FIG. 4 is a flowchart of an example process for updating the program instructions in the ECU.

FIG. 5 is a flowchart of an example process for updating, at a gateway module, program instructions for the ECU.

### DETAILED DESCRIPTION

A vehicle computer can receive program instruction updates for a plurality of electronic control units (ECUs) in a vehicle. Program instruction updates are typically (although not necessarily) provided to the vehicle computer at least in part wirelessly, e.g., as over the air (OTA) updates. Upon receiving an instruction from the vehicle computer, respective ECUs can remove current program instructions. The respective ECUs can then store the updated program instructions in response to receiving the updated program instructions from the vehicle computer. While the ECUs are updated, the vehicle computer may prevent the vehicle from operating. Due to limitations, including bandwidth limitations, of a vehicle communication network, the vehicle computer typically provides the updated program instructions to the respective ECUs in succession.

Advantageously, the vehicle computer can provide the updated program instructions to a gateway module that relays the updated program instructions to the ECUs. In this situation, respective ECUs can be updated simultaneously, which can reduce an amount of time for some or all of the plurality of ECUs to be updated as compared to updating the ECUs in succession. Additionally, upon determining that at least one ECU was not successfully updated, the vehicle computer can provide the current program instructions to the gateway module based on a number of attempts to update the at least one ECU being equal to a threshold, which can limit the amount of time that the ECUs are permitted to be updated. Reducing and/or limiting the amount of time for all of the ECUs to be updated allows the vehicle computer to update the ECUs more efficiently, thereby minimizing an amount of time that the vehicle is prevented from operating.

A system includes a computer, a plurality of electronic control units (ECUs), and a gateway module in communication with the computer and in communication with the plurality of ECUs. The computer is programmed to, upon receiving updated program instructions, provide an instruction, via the gateway module, to respective ones of the ECUs to remove current program instructions from respective memories of the ECUs. The computer is further programmed to, upon receiving in response to the instruction a message from the gateway module indicating that the current program instructions are removed from the ECUs' respective memories, provide the updated program instructions, via the gateway module, to the ECUs. The computer is further programmed to, upon receiving a message from the gateway module indicating that the updated program instructions are not stored in the respective memory of at least one of the ECUs, provide the updated program instructions, via the gateway module, based on a number of received messages indicating that the updated program instructions are not stored in the respective memory of at least one of the ECUs being less than a threshold.

The computer can be further programmed to, upon determining the number of received messages indicating that the updated program instructions are not stored in the respective memory of at least one of the ECUs is equal to the threshold, provide the current program instructions and an instruction to store the current program instructions.

The computer can be further programmed to, upon receiving a message from the gateway module indicating that the current program instructions are not stored in the respective memory of at least one ECU, prevent vehicle operation.

The computer can be further programmed to, upon receiving a message from the gateway module indicating that the current program instructions are not removed from at least one of the memories in response to the instruction, provide the instruction based on a number of received messages being less than the threshold.

The computer can be further programmed to, upon determining the number of received messages is equal to the threshold, provide the current program instructions and an instruction to store the current program instructions.

The computer can be further programmed to, upon receiving a message from the gateway module indicating that the current program instructions are not stored in the respective memory of at least one of the ECUs, prevent vehicle operation.

The computer can be further programmed to increment a counter in response to receiving one of the message indicating that the current program instructions are not removed from at least one of the memories or the message indicating that the updated program instructions are not stored in the respective memory of at least one of the ECUs. The computer can be further programmed to, upon determining the counter is equal to the threshold, provide, via the gateway module, the current program instructions and an instruction to store the current program instructions to the ECUs.

The computer can be further programmed to, upon receiving a message from the gateway module indicating that the current program instructions are not stored in the respective memory of at least one of the ECUs, prevent vehicle operation.

The ECUs can be programmed to, upon determining that the current program instructions are removed in response to the instruction, transmit a message to the gateway module indicating the current program instructions are removed. The ECUs can be further programmed to, upon determining that the current program instructions are not removed in response to the instruction, transmit a message to the gateway module indicating the current program instructions are not removed.

The gateway module can be programmed to identify a collective status of the ECUs that is one of removed or not removed based on whether the gateway module receives, from at least one of the ECUs, the message indicating the current program instructions are not removed. The gateway module can be further programmed to provide one of the message indicating that the current program instructions are removed from the ECUs' respective memories or the message indicating that the current program instructions are not removed from at least one of the memories to the computer based on the identified collective status.

The ECUs can be programmed to, upon determining that the updated program instructions are stored in the respective memory in response to receiving the updated program instructions, transmit a message to the gateway module indicating that the updated program instructions are stored. The ECUs can be further programmed to, upon determining that the updated program instructions are not stored in the respective memory in response to receiving the updated program instructions, transmit a message to the gateway module indicating that the updated program instructions are not stored.

The gateway module can be programmed to identify a collective status of the ECUs that is one of installed or not installed based on whether the gateway module receives, from at least one of the ECUs, the message indicating the updated program instructions are not stored. The gateway module can be further programmed to provide one of the message indicating that the updated program instructions are not stored in the respective memory of at least one of the ECUs or a message indicating that the updated program instructions are stored in the ECUs' respective memories to the computer based on the identified collective status.

A method includes, upon receiving, at a computer, updated program instructions, providing an instruction, via a gateway module, to respective ones of a plurality of ECUs to remove current program instructions from respective memories of the ECUs. The method further includes, upon receiving, at the computer, in response to the instruction a message from the gateway module indicating that the current program instructions are removed from the ECUs' respective memories, providing the updated program instructions, via the gateway module, to the ECUs. The method further includes, upon receiving, at the computer, a message from the gateway module indicating that the updated program instructions are not stored in the respective memory of at least one of the ECUs, providing the updated program instructions, via the gateway module, based on a number of received messages indicating that the updated program instructions are not stored in the respective memory of at least one of the ECUs being less than a threshold.

The method can further include, upon receiving, at the computer, a message from the gateway module indicating that the current program instructions are not removed from at least one of the memories in response to the instruction, providing the instruction based on a number of received messages indicating that the current program instructions are not removed from at least one of the memories being less than the threshold.

The method can further include incrementing a counter in response to receiving one of the message indicating that the current program instructions are not removed from at least one of the memories or the message indicating that the updated program instructions are not stored in the respective memory of at least one of the ECUs. The method can further include, upon determining the counter is equal to the threshold, providing, via the gateway module, the current program instructions and an instruction to store the current program instructions to the ECUs.

The method can further include, upon receiving a message from the gateway module indicating that the current program instructions are not stored in the respective memory of at least one of the ECUs, preventing vehicle operation.

The method can further include, upon determining, at the ECUs, that the current program instructions are removed in response to the instruction, transmitting a message to the gateway module indicating the current program instructions are removed. The method can further include, upon determining that the current program instructions are not removed in response to the instruction, transmitting a message to the gateway module indicating the current program instructions are not removed.

The method can further include identifying, at the gateway module, a collective status of the ECUs that is one of removed or not removed based on whether the gateway module receives, from at least one of the ECUs, the message indicating the current program instructions are not removed. The method can further include providing one of the message indicating that the current program instructions are removed from the ECUs' respective memories or the message indicating that the current program instructions are not removed from at least one of the memories to the computer based on the identified collective status

The method can further include, upon determining, at the ECUs, that the updated program instructions are stored in the respective memory in response to receiving the updated program instructions, transmitting a message to the gateway module indicating that the updated program instructions are stored. The method can further include, upon determining that the updated program instructions are not stored in the respective memory in response to receiving the updated program instructions, transmitting a message to the gateway module indicating that the updated program instructions are not stored.

The method can further include identifying, at the gateway module, a collective status of the ECUs that is one of installed or not installed based on whether the gateway module receives, from at least one of the ECUs, the message indicating the updated program instructions are not stored. The method can further include providing one of the message indicating that the updated program instructions are not stored in the respective memory of at least one of the ECUs or a message indicating that the updated program instructions are stored in the ECUs' respective memories to the computer based on the identified collective status.

Further disclosed herein is a computing device programmed to execute any of the above method steps. Yet further disclosed herein is a computer program product, including a computer readable medium storing instructions executable by a computer processor, to execute an of the above method steps.

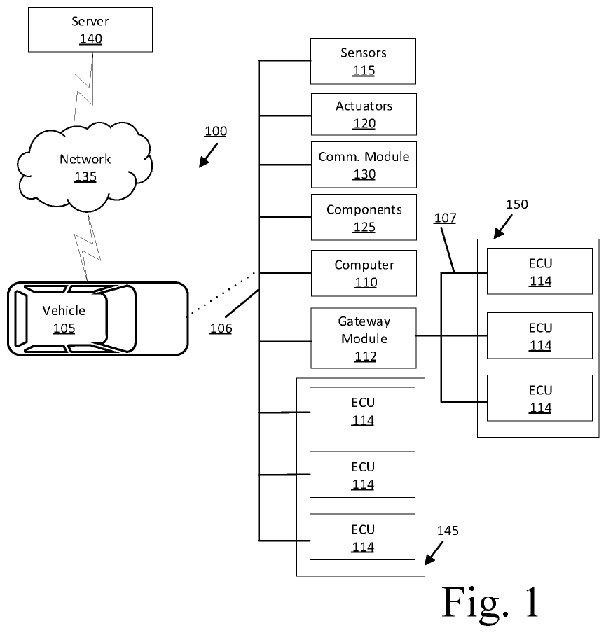

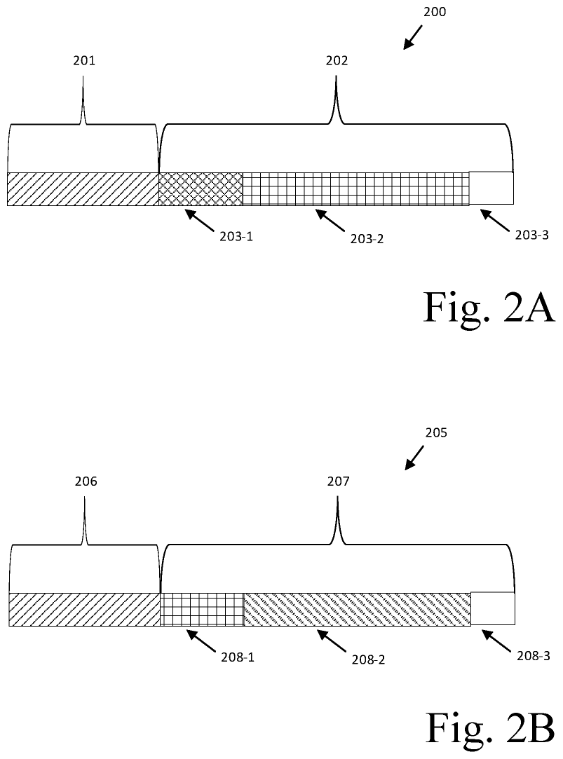

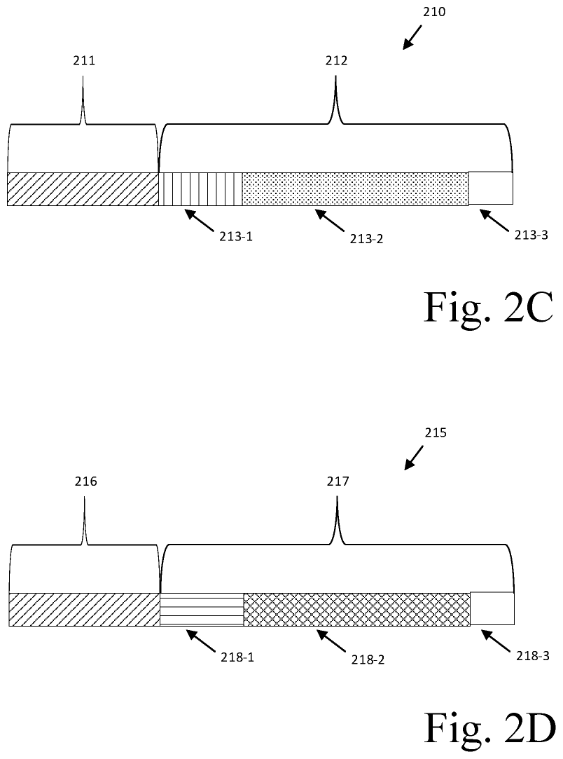

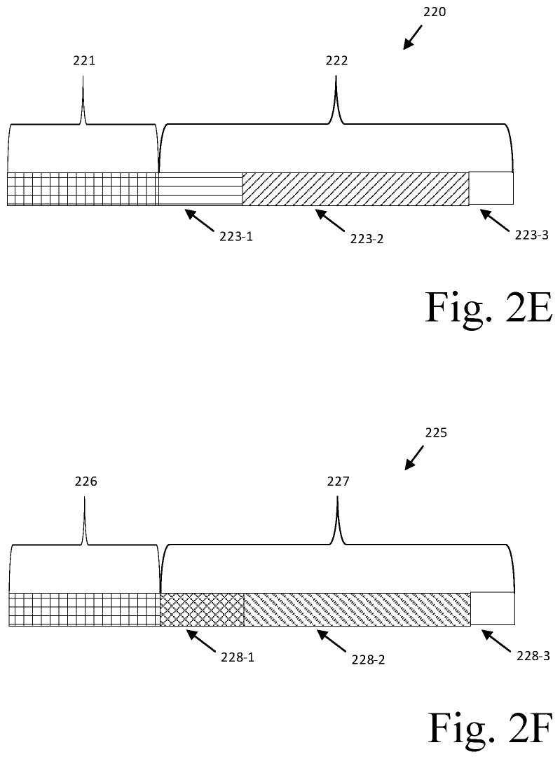

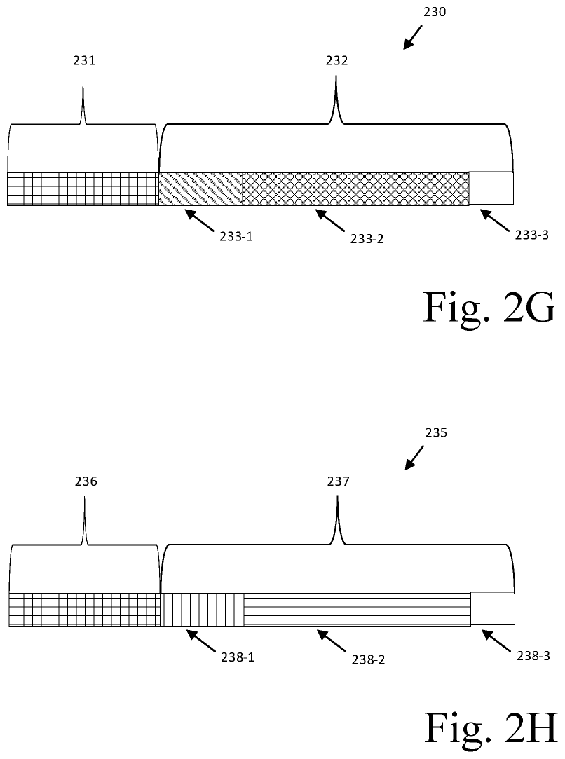

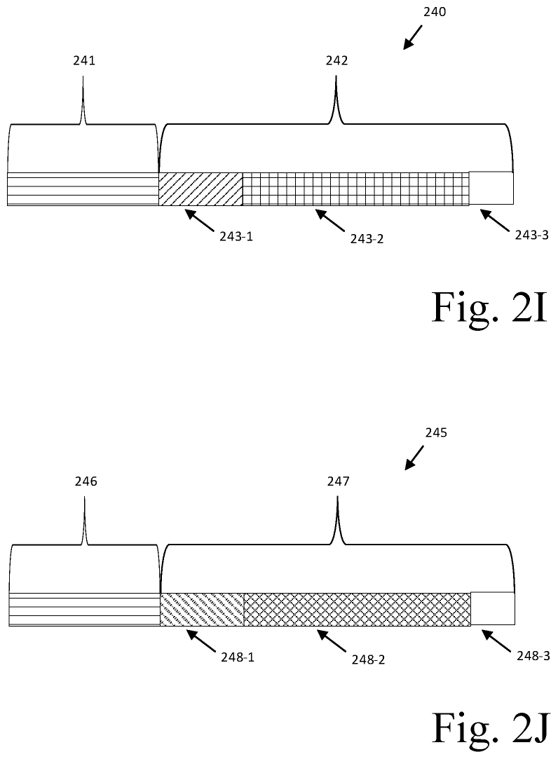

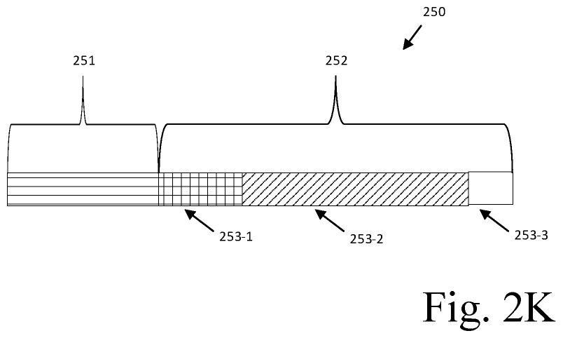

With reference to FIGS. 1-2K, an example control system 100 includes a vehicle 105. The vehicle 105 includes a first communication network 106 and a second communication network 107. The first and second communication networks 106, 107 represent respective in-vehicle networks by which various devices in the vehicle 105 may communicate with each other. A first subset, i.e., some but less than all, of the devices in the vehicle 105 are generally arranged for communications on the first communication network 106 that can include a first communication bus in the vehicle 105 such as a first controller area network (CAN) or the like, and/or other wired and/or wireless mechanisms. A second subset, i.e., some but less than all, of the devices in the vehicle 105 are generally arranged for communications on the second communication network 107 that can include a second communication bus in the vehicle 105 such as a second controller area network (CAN) or the like, and/or other wired and/or wireless mechanisms. The first and second communication networks 106, 107 may support a same or different communication protocol, e.g., CAN Local Interconnect Network (LIN), controller area network flexible data-rate (CAN FD), etc. At least one device, e.g., a gateway module 112, in the vehicle 105 is included in both the first and second subsets, i.e., is arranged for communications on the first and second communication networks 106, 107 (as discussed below). Arranging the respective subsets to communicate via different communication networks 106, 107 can advantageously reduce bandwidth on the first communication network 106 by preventing the devices in the second subset from communicating via the first communication network 106. Additionally, the different communication networks 106, 107 can reduce a risk that security of the second communication network 107 will be compromised by limiting communication via the second communication network 107 to the devices in the second subset, i.e., preventing devices unique to the first subset from communicating directly with devices unique to the second subset.

A vehicle computer 110 is connected to the first communication network 106. A plurality of electronic control units (ECUs) 114 are connected to the second communication network 107. The gateway module 112 is connected to the first communication network 106 and is in communication with the vehicle computer 110 via the first communication network 106. The gateway module 112 is connected to the second communication network 107 and is in communication with the plurality of ECUs 114 via the second communication network 107. The gateway module 112 facilitates communication between the vehicle computer 110 and the plurality of ECUs 114.

The vehicle computer 110 receives data from sensors 115 and the plurality of ECUs 114. The vehicle computer 110 is programmed to, upon receiving updated program instructions, provide an instruction message 200, via the gateway module 112, to respective ones of the ECUs 114 to remove current program instructions from respective memories of the ECUs 114. The vehicle computer 110 is further programmed to, upon receiving, in response to the instruction message 200, a first status message 240 from the gateway module 112 indicating that the current program instructions are removed from the ECUs' 114 respective memories, provide the updated program instructions, via the gateway module 112, to the ECUs 114. The vehicle computer 110 is further programmed to, upon receiving a second status message 245 from the gateway module 112 indicating that the updated program instructions are not stored in the respective memory of at least one of the ECUs 114, provide the updated program instructions, via the gateway module 112, based on a number of received second status messages 220 being less than a threshold.

Turning now to FIG. 1, the vehicle 105 includes the vehicle computer 110, a plurality of electronic control units (ECUs), sensors 115, actuators 120 to actuate various vehicle components 125, and a vehicle communication module 130. The communication module allows the computers to communicate with a remote server computer 140, and/or other vehicles, e.g., via a messaging or broadcast protocol such as Dedicated Short Range Communications (DSRC), Ultra-Wideband (UWB), cellular, and/or other protocol that can support vehicle-to-vehicle, vehicle-to infrastructure, vehicle-to-cloud communications, or the like, and/or via a packet network 135.

The vehicle computer 110 includes a processor and a memory such as are known. The memory includes one or more forms of computer-readable media, and stores instructions executable by the computer for performing various operations, including as disclosed herein. The vehicle computer 110 can further include two or more computing devices operating in concert to carry out vehicle 105 operations including as described herein. Further, the vehicle computer 110 can be a generic computer with a processor and memory as described above, and/or may include an electronic control unit (ECU) or electronic controller or the like for a specific function or set of functions, and/or may include a dedicated electronic circuit including an ASIC that is manufactured for a particular operation, e.g., an ASIC for processing sensor 115 data and/or communicating the sensor 115 data. In another example, the vehicle computer 110 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in the vehicle computer 110.

The vehicle computer 110 may operate and/or monitor the vehicle 105 in an autonomous mode, a semi-autonomous mode, or a non-autonomous (or manual) mode, i.e., can control and/or monitor operation of the vehicle 105, including controlling and/or monitoring components 125. For purposes of this disclosure, an autonomous mode is defined as one in which each of vehicle 105 propulsion, braking, and steering are controlled by the vehicle computer 110; in a semi-autonomous mode the vehicle computer 110 control one or two of vehicle 105 propulsion, braking, and steering; in a non-autonomous mode a human operator controls each of vehicle 105 propulsion, braking, and steering.

The vehicle computer 110 may include programming to operate one or more of vehicle 105 brakes, propulsion (e.g., control of acceleration in the vehicle 105 by controlling one or more of an internal combustion engine, electric motor, hybrid engine, etc.), steering, transmission, climate control, interior and/or exterior lights, horn, doors, etc., as well as to determine whether and when the vehicle computer 110, as opposed to a human operator, is to control such operations.

The vehicle computer 110 may include or be communicatively coupled to, e.g., via a vehicle communication network such as a communications bus as described further below, more than one processor, e.g., included in electronic controller units (ECUs) or the like included in the vehicle 105 for monitoring and/or controlling various vehicle components, e.g., a transmission controller, a brake controller, a steering controller, etc. The vehicle computer 110 is generally arranged for communications on the first communication network 106 that can include a bus in the vehicle 105 such as a controller area network (CAN) or the like, and/or other wired and/or wireless mechanisms.

Via the first communication network 106, the vehicle computer 110 may transmit messages to various devices in the vehicle 105 and/or receive messages (e.g., CAN messages) from the various devices, e.g., sensors 115, actuators 120, ECUs 114, the gateway module 112, other computers, etc. Alternatively, or additionally, in cases where the vehicle computer 110 actually comprises a plurality of devices, the first communication network 106 may be used for communications between devices represented as the vehicle computer 110 in this disclosure. Further, as mentioned below, various controllers and/or sensors 115 may provide data to the vehicle computer 110 via the first communication network 106.

Vehicle 105 sensors 115 may include a variety of devices such as are known, e.g., Light Detection And Ranging (LIDAR) sensor (s), radar sensors, camera sensors, etc. to provide data to the vehicle computer 110.

The vehicle 105 actuators 120 are implemented via circuits, chips, or other electronic and or mechanical components that can actuate various vehicle 105 subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a suspension component (e.g., that may include one or more of a damper, e.g., a shock or a strut, a bushing, a spring, a control arm, a ball joint, a linkage, etc.), a brake component, a park assist component, an adaptive cruise control component, an adaptive steering component, one or more passive restraint systems (e.g., airbags), a movable seat, etc.

In addition, the vehicle computer 110 may be configured for communicating via a vehicle-to-vehicle communication module 130 or interface with devices outside of the vehicle 105, e.g., through a vehicle-to-vehicle (V2V) or vehicle-to-infrastructure (V2X) wireless communications (cellular and/or short-range radio communications, etc.) to another vehicle, and/or to a remote server computer 140 (typically via direct radio frequency communications). The communication module could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communication module include cellular, Bluetooth, IEEE 802.11, dedicated short range communications (DSRC), cellular V2X (CV2X), and/or wide area networks (WAN), including the Internet, providing data communication services. For convenience, the label “V2X” is used herein for communications that may be vehicle-to-vehicle (V2V) and/or vehicle-to-infrastructure (V2I), and that may be provided by communication module 130 according to any suitable short-range communications mechanism, e.g., DSRC, cellular, or the like.

The network 135 represents one or more mechanisms by which a vehicle computer 110 may communicate with remote computing devices, e.g., the remote server computer 140, another vehicle computer, etc. Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks 135 include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

The plurality of ECUs 114 each includes a respective second processor and a respective second memory such as are known. Each second memory includes one or more forms of computer-readable media, and stores instructions executable by the respective ECU 114 for performing various operations, including as disclosed herein. For example, an ECU 114 can be programmed to monitor and/or control one or more vehicle components 125. The ECUs 114 may include a communication module that has features in common with the vehicle communication module 130. The communication module allows the ECU 114 to communicate with other computing devices, e.g., via messaging (e.g., CAN messages via one of the first communication network 106 or the second communication network 107).

The vehicle 105 can include a first set 145 of ECUs 114 that are connected to the first communication network 106, and a second set 150 of ECUs 114 that are connected to the second communication network 107. Via the second communication network 107, the gateway module 112 may transmit messages to the second set 150 of ECUs 114 and/or receive messages (e.g., CAN messages) from the second set 150 of ECUs 114. Only the gateway module 112 and the second set 150 of ECUs 114 may have access to, i.e., be able to transmit and/or receive messages, via the second communication network 107. That is, the vehicle computer 110 may communicate with the second set 150 of ECUs 114 via the gateway module 112.

The vehicle 105 gateway module 112 is a control module that connects and transmits data between different vehicle communication networks, e.g., the first and second communication networks 106, 107, that may operate according to different data transfer rates. That is, the gateway module 112 can facilitate wired or wireless communication among the vehicle computer 110 and the second set 150 of ECUs 114. For example, the gateway module 112 can schedule and perform communications between the vehicle computer 110 and the second set 150 of ECUs 114. The vehicle 105 gateway module 112 is a microprocessor-based computing device, e.g., a generic computing device including a processor and a memory, an electronic controller or the like, a field-programmable gate array (FPGA), an application-specific integrated circuit (ASIC), etc. The vehicle 105 gateway module 112 can thus include a third processor, a third memory, etc. The third memory of the vehicle 105 gateway module 112 can include media for storing instructions executable by the third processor as well as for electronically storing data and/or databases, and/or the vehicle 105 gateway module 112 can include structures such as the foregoing by which programming is provided.

The remote server computer 140 can be a conventional computing device, i.e., including one or more processors and one or more memories, programmed to provide operations such as disclosed herein. Further, the remote server computer 140 can be accessed via the network 135, e.g., the Internet, a cellular network, and/or or some other wide area network.

The vehicle computer 110 is programmed to receive updated program instructions from the remote server computer 140. For example, the remote server computer 140 can transmit the updated program instructions to the vehicle computer 110, e.g., via the network 135. The vehicle computer 110 can monitor the network 135 for the updated program instructions. The updated program instructions can include a version number, e.g., in a specified section of the updated program instructions. Upon receiving the updated program instructions, the vehicle computer 110 can access the updated program instructions, e.g., the specified section, and retrieve the version number. The vehicle computer 110 can then store, e.g., in a memory of the vehicle computer 110, the version number of the updated program instructions. In this context, a “version number” is a string of data corresponding to the specific program instructions, i.e., an identifier for the program instructions. The version number can be, e.g., a string of alphanumeric bits, a string of binary digits, a string of hexadecimal digits, etc.

Program instructions, in the present context, are digital data executable by a processor, typically in the form of object code, i.e., compiled executable code. Program instructions may be stored in a binary format, for example. In one example, a set of program instructions is executable computer code for a computer program or application. Further, an example of a set of program instructions can be provided as a set or package of files, i.e., the respective files in a package of program instructions are respective portions of the package.

A set of program instructions, e.g., embodying a program or application, can be used to provide an operational feature of a machine or system. An operational feature of a machine or system, e.g., a vehicle 105, means functionality provided by executing program instructions (i.e., computer-executable instructions) to perform an action by receiving input data and outputting output data based on the received input data. A few of many possible examples of operational features include actuating movement of a machine, such as a robot, aerial drone, vehicle 105, etc., actuating communications, e.g., in a network 135 device such as a gateway or router, actuating a display (e.g., in a vehicle 105 information or entertainment system), etc.

In the present context, updating an operational feature includes (i) replacing current program instructions of an operational feature in an ECU 114 with received updated program instructions for the respective operational feature, e.g., upgrading from a first version to a second version, and/or (ii) adding a new operational feature to the ECU 114. An ECU 114 typically includes a reprogramming operational feature for adding, removing, and/or updating an operational feature of the ECU 114. Reprogramming includes writing program instructions in a section of ECU 114 memory from which the ECU 114 is programmed to perform an operational feature.

Upon receiving the updated program instructions, the vehicle computer 110 can output a message to a user of the vehicle 105, e.g., via a human-machine interface (HMI) such as a touchscreen display, indicating that received updated program instructions will be installed to various devices, e.g., ECUs 114, in the vehicle 105. The message may, for example, specify a time, e.g., a day of the week and/or a time of the day, at which the installation of the received updated program instructions will initiate. Alternatively, the vehicle computer 110 can detect a user input, e.g., via the user pressing a virtual button displayed on the HMI, specifying a time to initiate installation of the received updated program instructions. The vehicle computer 110 can initiate installation of the received updated program instructions based on the user input.

At the specified time, the vehicle computer 110 can enable a safe mode, i.e., transition the safe mode from a disabled state to an enabled state. The safe mode prevents operation of the vehicle 105. That is, the safe mode prevents actuation of one or more vehicle components such that the vehicle 105 is prevented from moving, i.e., remains stationary, while the safe mode is enabled. For example, the vehicle computer 110 may not send, or may be prevented from sending, instructions to one or more vehicle components 125, e.g., a propulsion component, when the safe mode is enabled.

While the safe mode is enabled, the vehicle computer 110 can generate an instruction message 200. An instruction message 200 includes a header 201 and a payload 202 (see FIG. 2A). The header 201 of the instruction message 200 may include a message type, a message size, an identifier of the vehicle computer 110, etc. The payload 202 may include various data, i.e., message content. The payload 202 can include sub-payloads or payload segments 203-1, 203-2, 203-3 (collectively, referred to as payload segments 203). The respective payload segments 203 in FIG. 2A are illustrated as being of different lengths to reflect that different payload segments 203 may include various amount of data, and therefore may be of different sizes, i.e., lengths. For example, the vehicle computer 110 can include an instruction to remove current program instructions from a respective memory in, e.g., a specified payload segment 203 of, the payload 202 of the instruction message 200.

Upon generating the instruction message 200, the vehicle computer 110 can then provide the instruction message 200 to respective ECUs 114 in the second set 150 of ECUs 114. For example, the vehicle computer 110 can transmit the instruction message 200 to respective ECUs 114 in the second set 150 of ECUs 114 via the gateway module 112. In other words, the vehicle computer 110 can transmit the instruction message 200 to the gateway module 112, e.g., via the first communication network 106, and the gateway module 112 can relay the instruction message 200 to respective ECUs 114 in the second set 150 of ECUs 114, as discussed further below.

Upon providing the instruction message 200, the vehicle computer 110 is typically programmed to monitor the first communication network 106 for a first status message 240 (described below) from the gateway module 112 indicating a first collective status of the ECUs 114 in the second set 150 of ECUs 114. The first collective status of the ECUs 114 in the second set 150 of ECUs 114 is one of “removed” or “not removed”, as discussed further below. The vehicle computer 110 can determine the first collective status of the ECUs 114 in the second set 150 of ECUs 114 based on the first status message 240. For example, the vehicle computer 110 can access a payload 242, e.g., a specified payload segment 243, of the first status message 240 and retrieve the first collective status of the ECUs 114 in the second set 150 of ECUs 114.

If the vehicle computer 110 determines that the first collective status of the ECUs 114 in the second set 150 of ECUs 114 is “removed”, then the vehicle computer 110 can provide the updated program instructions to the ECUs 114 in the second set 150 of ECUs 114. For example, the vehicle computer 110 can generate an installation message 205. Similar to the instruction message 200, the installation message 205 includes a header 206 and a payload 207, including payload segments 208 (see FIG. 2B). The header 206 of the installation message 205 may include a message type, a message size, an identifier of the vehicle computer 110, etc. The payload 207 may include various data, i.e., message content. The vehicle computer 110 can include the updated program instructions in, e.g., a specified payload segment 208 of, the payload 207 of the installation message 205. The vehicle computer 110 can then provide the installation message 205 to the respective ECUs 114 in the second set 150 of ECUs 114, e.g., in substantially the same manner as discussed above regarding providing the instruction message 200 to ECUs 114 in the second set 150 of ECUs 114.

If the vehicle computer 110 determines that the first collective status of the ECUs 114 in the second set 150 of ECUs 114 is “not removed”, then the vehicle computer 110 can increment a counter. The vehicle computer 110 can store the counter, e.g., in a memory of the vehicle computer 110. Upon incrementing the counter, the vehicle computer 110 overwrites, e.g., in the memory, the counter with the incremented counter. The counter indicates a number of messages indicating at least one of a) the first collective status of the ECUs 114 is “not removed”, or b) the second collective status (as discussed below) of the ECUs 114 is “not installed”.

The vehicle computer 110 is typically programmed to compare the incremented counter to a threshold. The threshold may be stored, e.g., in a memory of the vehicle computer 110. The threshold specifies a maximum number of attempts permitted to install the updated program instructions. The threshold can be determined empirically, e.g., based on testing that allows for determining a number of attempts that can be initiated within a predetermined time such that the updated program instructions can be installed to respective ECUs 114 within the predetermined time. The determined time may be specified by, e.g., a vehicle 105 and/or component 125 manufacturer, to minimize an amount of time that the vehicle 105 is in the safe mode. If the incremented counter is less than the threshold, then the vehicle computer 110 can provide the instruction message 200 to the respective ECUs 114 in the second set 150 of ECUs 114, as discussed above.

If the incremented counter equals the threshold, then the vehicle computer 110 can provide the current program instructions to the ECUs 114 in the second set 150 of ECUs 114. For example, the vehicle computer 110 can generate a reinstallation message 210. Similar to the instruction message 200, the reinstallation message 210 includes a header 211 and a payload 212, including payload segments 213 (see FIG. 2C). The header 211 of the reinstallation message 210 may include a message type, a message size, an identifier of the vehicle computer 110, etc. The payload 212 may include various data, i.e., message content. The vehicle computer 110 can include the current program instructions in, e.g., a specified payload segment 213 of, the payload 212 of the reinstallation message 210. The vehicle computer 110 can then provide the reinstallation message 210 to the respective ECUs 114 in the second set 150 of ECUs 114, e.g., in substantially the same manner as discussed above regarding providing the instruction message 200 to ECUs 114 in the second set 150 of ECUs 114.

Upon providing the installation message 205, the vehicle computer 110 is typically programmed to monitor the first communication network 106 for a second status message 245 (described below) from the gateway module 112 indicating a second collective status of the ECUs 114 in the second set 150 of ECUs 114. The second collective status of the ECUs 114 in the second set 150 of ECUs 114 is one of “installed” or “not installed”, as discussed further below. The vehicle computer 110 can determine the second collective status of the ECUs 114 in the second set 150 of ECUs 114 based on the second status message 245. For example, the vehicle computer 110 can access a payload 247, e.g., a specified payload segment 248, of the second status message 245 and retrieve the second collective status of the ECUs 114 in the second set 150 of ECUs 114.

If the vehicle computer 110 determines that the second collective status of the ECUs 114 in the second set 150 of ECUs 114 is “not installed”, then the vehicle computer 110 can increment the counter. The vehicle computer 110 can then compare the incremented counter to the threshold, as discussed above. If the incremented counter is less than the threshold, then the vehicle computer 110 can provide the installation message 205 to the respective ECUs 114 in the second set 150 of ECUs 114, as discussed above. If the incremented counter equals the threshold, then the vehicle computer 110 can provide the reinstallation message 210 to the respective ECUs 114 in the second set 150 of ECUs 114, as discussed above.

If the vehicle computer 110 determines that the second collective status of the ECUs 114 in the second set 150 of ECUs 114 is “installed”, then the vehicle computer 110 can generate a request message 215. Similar to the instruction message 200, the request message 215 includes a header 216 and a payload 217, including payload segments 218 (see FIG. 2D). The header 216 of the request message 215 may include a message type, a message size, an identifier of the vehicle computer 110, etc. The payload 217 may include various data, i.e., message content. The vehicle computer 110 can include a request to provide a version number associated with the updated program instructions in, e.g., a specified payload segment 218 of, the payload 217 of the request message 215. The vehicle computer 110 can then provide the request message 215 to the respective ECUs 114 in the second set 150 of ECUs 114, e.g., in substantially the same manner as discussed above regarding providing the instruction message 200 to ECUs 114 in the second set 150 of ECUs 114.

Upon providing the request message 215, the vehicle computer 110 is typically programmed to monitor the first communication network 106 for a plurality of reply messages 235 from the respective ECUs 114 in the second set 150 of ECUs 114 indicating a respective version number associated with the updated program instructions. That is, the vehicle computer 110 can receive a unique reply message 235 from the respective ECUs 114 in the second set 150 of ECUs 114. The vehicle computer 110 can access a payload 237, e.g., a specified payload segment 238, of the respective reply message 235 and retrieve the respective version number. The vehicle computer 110 can then compare the respective retrieved version numbers with the stored version number. If one of the retrieved versions numbers does not match the stored version number, the vehicle computer 110 maintains the safe mode in the enabled state. In this situation, the vehicle computer 110 may output a message, e.g., via an HMI, indicating that the installation of the updated program instructions was unsuccessful.

If each of the retrieved version numbers matches the stored version number, then the vehicle computer 110 can verify that the respective ECUs 114 in the second set 150 of ECUs 114 includes the updated program instructions. Upon verifying that the respective ECUs 114 in the second set 150 of ECUs 114 includes the updated program instructions, the vehicle computer 110 disables the safe mode, i.e., transitions the safe mode from the enabled state to the disabled state. That is, the vehicle computer 110 can actuate one or more vehicle components to move the vehicle 105 based on the respective ECUs 114 in the second set 150 of ECUs 114 operating according to the updated program instructions. The vehicle computer 110 may output a message, e.g., via the HMI, indicating that the installation of the updated program instructions was successful.

In the example in which the vehicle computer 110 provides the reinstallation message 210, the vehicle computer 110 is typically programmed to monitor the first communication network 106 for a third status message 250 (described below) from the gateway module 112 indicating a third collective status of the ECUs 114 in the second set 150 of ECUs 114. The third collective status of the ECUs 114 in the second set 150 of ECUs 114 is one of “reinstalled” or “not reinstalled”, as discussed further below. The vehicle computer 110 can determine the third collective status of the ECUs 114 in the second set 150 of ECUs 114 based on the third status message 250. For example, the vehicle computer 110 can access a payload 252, e.g., a specified payload segment 253, of the third status message 250 and retrieve the third collective status of the ECUs 114 in the second set 150 of ECUs 114.

If the vehicle computer 110 determines that the third collective status of the ECUs 114 in the second set 150 of ECUs 114 is “not reinstalled”, then the vehicle computer 110 can maintain the safe mode in the enabled state. In this situation, the vehicle computer 110 can output a message, e.g., via an HMI, indicating that the installation of the updated program instructions was unsuccessful.

If the vehicle computer 110 determines that the third collective status of the ECUs 114 in the second set 150 of ECUs 114 is “reinstalled”, then the vehicle computer 110 can verify that the respective ECUs 114 in the second set 150 of ECUs 114 includes the current program instructions. In this situation, the vehicle computer 110 can disable the safe mode, i.e., transition the safe mode from the enabled state to the disabled state. That is, the vehicle computer 110 can actuate one or more vehicle components to move the vehicle 105 based on the respective ECUs 114 in the second set 150 of ECUs 114 operating according to the current program instructions.

Respective ECUs 114 in the second set 150 of ECUs 114 may be programmed to remove current program instructions from a respective memory in response to receiving the instruction message 200. Upon removing the current program instructions, the respective ECUs 114 in the second set 150 of ECUs 114 can verify that the current program instructions were removed from the respective memory. For example, the respective ECUs 114 in the second set 150 of ECUs 114 can access a section of the respective memories specified to store current program instructions. If the specified section of the respective memory is empty, i.e., lacks data, then an ECU 114 verifies that the current program instructions are removed. If the specified section of the respective memory is not empty, i.e., includes data, then the ECU 114 determines that the current program instructions are removed.

Upon verifying that the current program instructions are removed from the respective memory or determining that the current program instructions are not removed from the respective memory, a respective ECU 114 can generate a first update message 220. Similar to the instruction message 200, the first update message 220 includes a header 221 and a payload 222, including payload segments 223 (see FIG. 2E). The header 221 of the first update message 220 may include a message type, a message size, an identifier of the respective ECU 114, etc. The payload 222 may include various data, i.e., message content. If the respective ECU 114 verified that the current program instructions are removed, then the respective ECU 114 can include data indicating that the current program instructions are removed in, e.g., a specified payload segment 223 of, the payload 222 of the first update message 220. If the respective ECU 114 determined that the current program instructions are not removed, then the respective ECU 114 can include data indicating that the current program instructions are not removed in, e.g., a specified payload segment 223 of, the payload 222 of the first update message 220. The respective ECU 114 can then provide the first update message 220 to the gateway module 112. For example, the respective ECU 114 can transmit the first update message 220 to the gateway module 112, e.g., via the second communication network 107.

Respective ECUs 114 in the second set 150 of ECUs 114 may be programmed to store the updated program instructions in a respective memory in response to receiving the installation message 205. Upon storing the updated program instructions, the respective ECUs 114 in the second set 150 of ECUs 114 can verify that the updated program instructions were stored in the respective memory. For example, the respective ECUs 114 in the second set 150 of ECUs 114 can access the section of the respective memories specified to store current program instructions. If the specified section of the respective memory is empty, i.e., lacks data, then an ECU 114 determines that the updated program instructions are not stored in a respective memory. If the specified section of the respective memory is not empty, i.e., includes data, then the ECU 114 verifies that the updated program instructions are stored in a respective memory.

Upon verifying that the updated program instructions are stored in the respective memory or determining that the updated program instructions are not stored in the respective memory, the respective ECU 114 can generate a second update message 225. Similar to the instruction message 200, the second update message 225 includes a header 226 and a payload 227, including payload segments 228 (see FIG. 2F). The header 226 of the second update message 225 may include a message type, a message size, an identifier of the respective ECU 114, etc. The payload 227 may include various data, i.e., message content. If the respective ECU 114 verified that the updated program instructions are stored, then the respective ECU 114 can include data indicating that the updated program instructions are stored in, e.g., a specified payload segment 228 of, the payload 227 of the second update message 225. If the respective ECU 114 determined that the updated program instructions are not stored, then the respective ECU 114 can include data indicating that the updated program instructions are not stored in, e.g., a specified payload segment 228 of, the payload 227 of the second update message 225. The respective ECU 114 can then provide the second update message 225 to the gateway module 112, e.g., in substantially the same manner as discussed above regarding providing the first update message 220 to the gateway module 112.

Respective ECUs 114 in the second set 150 of ECUs 114 may be programmed to store the current program instructions in a respective memory in response to receiving the reinstallation message 210. Upon storing the current program instructions, the respective ECUs 114 in the second set 150 of ECUs 114 can verify that the current program instructions were stored in the respective memory, e.g., in substantially the same manner as discussed above regarding verifying whether the updated program instructions were stored in the respective memory.

Upon verifying that the current program instructions are stored in the respective memory or determining that the current program instructions are not stored in the respective memory, the respective ECU 114 can generate a third update message 230. Similar to the instruction message 200, the third update message 230 includes a header 231 and a payload 232, including payload segments 233 (see FIG. 2G). The header 231 of the third update message 230 may include a message type, a message size, an identifier of the respective ECU 114, etc. The payload 232 may include various data, i.e., message content. If the respective ECU 114 verified that the updated program instructions are stored, then the respective ECU 114 can include data indicating that the updated program instructions are stored in, e.g., a specified payload segment 233 of, the payload 232 of the third update message 230. If the respective ECU 114 determined that the updated program instructions are not stored, then the respective ECU 114 can include data indicating that the updated program instructions are not stored in, e.g., a specified payload segment 233 of, the payload 232 of the third update message 230. The respective ECU 114 can then provide the third update message 230 to the gateway module 112, e.g., in substantially the same manner as discussed above regarding providing the first update message 220 to the gateway module 112.

Respective ECUs 114 in the second set 150 of ECUs 114 may be programmed to provide a version number associated with the updated program instructions in response to receiving the request message 215. For example, the respective ECUs 114 can access a specified section of the updated program instructions and retrieve the version number. The respective ECUs 114 can then generate respective reply messages 235. Similar to the instruction message 200, the reply message 235 includes a header 236 and a payload 237, including payload segments 238 (see FIG. 2H). The header 236 of the reply message 235 may include a message type, a message size, an identifier of the respective ECU 114, etc. The payload 237 may include various data, i.e., message content. The ECU 114 can include the retrieved version number in, e.g., a specified payload segment 238 of, the payload 237 of the reply message 235. The respective ECU 114 can then provide the reply message 235 to the gateway module 112, e.g., in substantially the same manner as discussed above regarding providing the first update message 220 to the gateway module 112.

The gateway module 112 may be programmed to relay the instruction message 200 from the vehicle computer 110 to the respective ECUs 114 in the second set 150 of ECUs 114. The gateway module 112 can monitor the first communication network 106 to detect the instruction message 200. Upon receiving the reinstallation message 210, the gateway module 112 can then transmit the instruction message 200 to the respective ECUs 114 in the second set 150 of ECUs 114, e.g., via the second communication network 107.

Upon transmitting the instruction message 200 to the respective ECUs 114 in the second set 150 of ECUs 114, the gateway module 112 may be programmed to identify a first collective status of the ECUs 114 in the second set 150 of ECUs 114 as one of “removed” or “not removed”. The gateway module 112 is typically programmed to monitor the second communication network 107 to detect first update messages 220 from the respective ECUs 114 in the second set 150 of ECUs 114. Upon receiving a first update message 220 from one of the ECUs 114, the gateway module 112 can determine whether the current program instructions were removed from a respective memory of the one ECU 114. For example, the gateway module 112 can access the payload 222, e.g., the specified payload segment 223, of the first update message 220 and retrieve the data indicating whether the current program instructions are removed. The gateway module 112 can continue to determine whether the current program instructions were removed from a respective memory of an ECU 114 in this manner until the gateway module 112 has determined whether the current program instructions were removed from respective memories of the ECUs 114 of the second set 150 of ECUs 114.

The gateway module 112 can then generate a first status message 240 based on whether at least one first update message 220 indicates that the current program instructions were not removed from a respective memory of a corresponding ECU 114. Similar to the instruction message 200, the first status message 240 includes a header 241 and a payload 242, including payload segments 243 (see FIG. 2I). The header 241 of the first status message 240 may include a message type, a message size, an identifier of the gateway module 112, etc. The payload 242 may include various data, i.e., message content. If the gateway module 112 determines that each of the first update messages 220 indicated that the current program instructions were removed from the respective memories of the ECUs 114 in the second set 150 of ECUs 114, then the gateway module 112 can include data indicating that the first collective status of the ECUs 114 in the second set 150 of ECUs 114 is “removed” in, e.g., a specified payload segment 243 of, the payload 242 of the first status message 240. If the gateway module 112 determines that at least one of the first update messages 220 indicated that the current program instructions were not removed from the respective memory of a corresponding ECU 114 in the second set 150 of ECUs 114, then the gateway module 112 can include data indicating that the first collective status of the ECUs 114 in the second set 150 of ECUs 114 is “not removed” in, e.g., a specified payload segment 243 of, the payload 242 of the first status message 240. The gateway module 112 can then provide the first status message 240 to the vehicle computer 110. For example, the gateway module 112 can transmit the first status message 240 to the vehicle computer 110, e.g., via the first communication network 106.

The gateway module 112 may be programmed to relay the installation message 205 from the vehicle computer 110 to the respective ECUs 114 in the second set 150 of ECUs 114, e.g., in substantially the same manner as discussed above regarding relaying the instruction message 200.

Upon transmitting the installation message 205 to the respective ECUs 114 in the second set 150 of ECUs 114, the gateway module 112 may be programmed to identify a second collective status of the ECUs 114 in the second set 150 of ECUs 114 as one of “installed” red or “not installed”. The gateway module 112 is typically programmed to monitor the second communication network 107 to detect second update messages 225 from the respective ECUs 114 in the second set 150 of ECUs 114. Upon receiving a second update message 225 from one of the ECUs 114, the gateway module 112 can determine whether the updated program instructions were stored in a respective memory of the one ECU 114. For example, the gateway module 112 can access the payload 227, e.g., the specified payload segment 228, of the second update message 225 and retrieve the data indicating whether the updated program instructions are stored in a respective memory of the one ECU 114. The gateway module 112 can continue to determine whether the updated program instructions were stored in a respective memory of an ECU 114 in this manner until the gateway module 112 has determined whether the updated program instructions were stored in respective memories of the ECUs 114 of the second set 150 of ECUs 114.

The gateway module 112 can then generate a second status message 245 based on whether at least one second update message 225 indicates that the updated program instructions were not stored in a respective memory of a corresponding ECU 114. Similar to the instruction message 200, the second status message 245 includes a header 246 and a payload 247, including payload segments 248 (see FIG. 2J). The header 246 of the second status message 245 may include a message type, a message size, an identifier of the gateway module 112, etc. The payload 247 may include various data, i.e., message content. If the gateway module 112 determines that each of the second update messages 225 indicated that the updated program instructions were stored in the respective memories of the ECUs 114 in the second set 150 of ECUs 114, then the gateway module 112 can include data indicating that the second collective status of the ECUs 114 in the second set 150 of ECUs 114 is “installed” in, e.g., a specified payload segment 248 of, the payload 247 of the second status message 245. If the gateway module 112 determines that at least one of the second update messages 225 indicated that the updated program instructions were not stored in the respective memory of a corresponding ECU 114 in the second set 150 of ECUs 114, then the gateway module 112 can include data indicating that the second collective status of the ECUs 114 in the second set 150 of ECUs 114 is “not installed” in, e.g., a specified payload segment 248 of, the payload 247 of the second status message 245. The gateway module 112 can then provide the second status message 245 to the vehicle computer 110, e.g., in substantially the same manner as discussed above regarding providing the first status message 240 to the vehicle computer 110.

The gateway module 112 may be programmed to relay the reinstallation message 210 from the vehicle computer 110 to the respective ECUs 114 in the second set 150 of ECUs 114, e.g., in substantially the same manner as discussed above regarding relaying the instruction message 200.

Upon transmitting the reinstallation message 210 to the respective ECUs 114 in the second set 150 of ECUs 114, the gateway module 112 may be programmed to identify a third collective status of the ECUs 114 in the second set 150 of ECUs 114 as one of “reinstalled” or “not reinstalled”. The gateway module 112 monitors the second communication network 107 to detect third update messages 230 from the ECUs 114 in the second set 150 of ECUs 114. Upon receiving a third update message 230 from one of the ECUs 114, the gateway module 112 can determine whether the current program instructions were stored in a respective memory of the one ECU 114. For example, the gateway module 112 can access the payload 232, e.g., the specified payload segment 233, of the third update message 230 and retrieve the data indicating whether the current program instructions are stored in a respective memory of the one ECU 114. The gateway module 112 can continue to determine whether the current program instructions were stored in a respective memory of an ECU 114 in this manner until the gateway module 112 has determine whether the current program instructions were stored in respective memories of the ECUs 114 of the second set 150 of ECUs 114.

The gateway module 112 can then generate a third status message 250 based on whether at least one message indicated that the current program instructions were not stored in a respective memory of a corresponding ECU 114. Similar to the instruction message 200, the third status message 250 includes a header 251 and a payload 252, including payload segments 253 (see FIG. 2K). The header 251 of the third status message 250 may include a message type, a message size, an identifier of the gateway module 112, etc. The payload 252 may include various data, i.e., message content. If the gateway module 112 determines that each of the third update messages 230 indicated that the current program instructions were stored in the respective memories of the ECUs 114 in the second set 150 of ECUs 114, then the gateway module 112 can include data indicating that the third collective status of the ECUs 114 in the second set 150 of ECUs 114 is “reinstalled” in, e.g., a specified payload segment 253 of, the payload 252 of the second status message 245. If the gateway module 112 determines that at least one of the third update messages 230 indicated that the current program instructions were not stored in the respective memory of a corresponding ECU 114 in the second set 150 of ECUs 114, then the gateway module 112 can include data indicating that the second collective status of the ECUs 114 in the second set 150 of ECUs 114 is “not reinstalled” in, e.g., a specified payload segment 253 of, the payload 252 of the second status message 245. The gateway module 112 can then provide the third status message 250 to the vehicle computer 110, e.g., in substantially the same manner as discussed above regarding providing the first status message 240 to the vehicle computer 110.

The gateway module 112 may be programmed to relay the request message 215 from the vehicle computer 110 to the respective ECUs 114 in the second set 150 of ECUs 114, e.g., in substantially the same manner as discussed above regarding relaying the instruction message 200.

The gateway module 112 may be programmed to relay the reply messages 235 indicating the retrieved version number from the respective ECUs 114 in the second set 150 of ECUs 114. For example, the gateway module 112 can monitor the second communication network 107 to detect a plurality of reply messages 235, e.g., respective reply messages 235 from the respective ECUs 114 in the second set 150 of ECUs 114. The gateway module 112 can then transmit the plurality of reply messages 235 to the vehicle computer 110, e.g., via the first communication network 106, in an order in which the gateway module 112 received the reply messages 235.

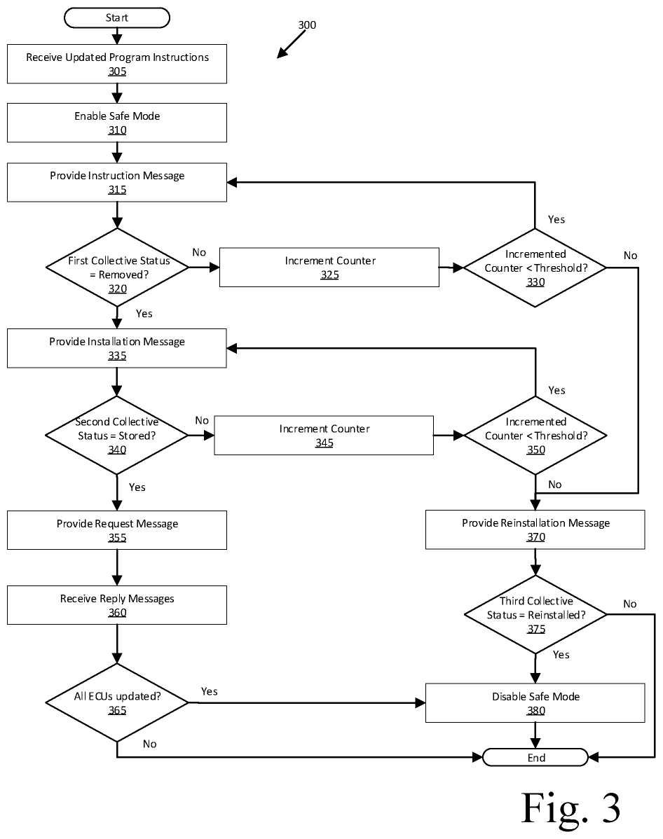

FIG. 3 is a diagram of an example process 300 executed in a vehicle computer 110 in a vehicle 105 according to program instructions stored in a memory thereof for updating program instructions in a plurality of ECUs 114.

The process 300 begins in a block 305. In the block 305, the vehicle computer 110 receives updated program instructions from a remote server computer 140, e.g., via the network 135, as discussed above. The process 300 continues in a block 310.

In the block 310, the vehicle computer 110 transitions a safe mode to an enabled state. As set forth above, the safe mode prevents operation of the vehicle 105. The process 300 continues in a block 315.

In the block 315, the vehicle computer 110 provides an instruction message 200 to the respective ECUs 114 in a second set 150 of ECUs 114. The vehicle computer 110 generates the instruction message 200 and transmits the instruction message 200 to the respective ECUs 114 in the second set 150 of ECUs 114 via the gateway module 112, as discussed above. The process 300 continues in a block 320.

In the block 320, the vehicle computer 110 determines whether a first collective status of the ECUs 114 in the second set 150 of ECUs 114 is one of “removed” or “not removed”. The vehicle computer 110 determines the first collective status based on a first status message 240 from the gateway module 112, as discussed above. If the vehicle computer 110 determines that the first collective status is “removed”, then the process 300 continues in a block 325. Otherwise, the process 300 continues in a block 325.

In the block 325, the vehicle computer 110 increments a counter, as discussed above. The process 300 continues in a block 330.

In the block 330, the vehicle computer 110 determines whether the incremented counter is less than a threshold. The vehicle computer 110 compares the incremented counter to the threshold. If the incremented counter is less than the threshold, then the process 300 returns to the block 315. If the incremented counter is greater than or equal to the threshold, then the process 300 continues in a block 370.

In the block 335, the vehicle computer 110 provides an installation message 205 to the respective ECUs 114 in a second set 150 of ECUs 114. The vehicle computer 110 generates the installation message 205 and transmits the installation message 205 to the respective ECUs 114 in the second set 150 of ECUs 114 via the gateway module 112, as discussed above. The process 300 continues in a block 340.

In the block 340, the vehicle computer 110 determines whether a second collective status of the ECUs 114 in the second set 150 of ECUs 114 is one of “installed” or “not installed”. The vehicle computer 110 determines the second collective status based on a second status message 245 from the gateway module 112, as discussed above. If the vehicle computer 110 determines that the second collective status is “installed”, then the process 300 continues in a block 355. Otherwise, the process 300 continues in a block 345.

In the block 345, the vehicle computer 110 increments the counter, as discussed above. The process 300 continues in a block 350.

In the block 350, the vehicle computer 110 determines whether the incremented counter is less than a threshold. The block 350 is substantially the same as the block 320 of process 300 and therefore will not be described further to avoid redundancy. If the incremented counter is less than the threshold, then the process 300 returns to the block 335. If the incremented counter is greater than or equal to the threshold, then the process 300 continues in a block 370.

In the block 355, the vehicle computer 110 provides a request message 215 to the respective ECUs 114 in a second set 150 of ECUs 114. The vehicle computer 110 generates the request message 215 and transmits the request message 215 to the respective ECUs 114 in the second set 150 of ECUs 114 via the gateway module 112, as discussed above. The process 300 continues in a block 360.

In the block 360, the vehicle computer 110 receives a plurality of reply messages 235 from the respective ECUs 114 in the second set 150 of ECUs 114, as discussed above. The vehicle computer 110 retrieves the respective version number from each of the plurality of reply messages 235, as discussed above. The process 300 continues in a block 365.

In the block 365, the vehicle computer 110 verifies whether the respective ECUs 114 in the second set 150 of ECUs 114 includes the updated program instructions. The vehicle computer 110 can compare each retrieved version number with a stored version number, as discussed above. If each of the retrieved version numbers matches the stored version number, then the vehicle computer 110 verifies that the respective ECUs 114 in the second set 150 of ECUs 114 includes the updated program instructions. If one of the retrieved versions numbers does not match the stored version number, the vehicle computer 110 maintains the safe mode in the enabled state. If the vehicle computer 110 verifies the respective ECUs 114 in the second set 150 of ECUs 114 includes the updated program instructions, then the process 300 continues in a block 380. Otherwise, the process 300 ends following the block 365.

In the block 370, the vehicle computer 110 provides a reinstallation message 210 to the respective ECUs 114 in a second set 150 of ECUs 114. The vehicle computer 110 generates the reinstallation message 210 and transmits the reinstallation message 210 to the respective ECUs 114 in the second set 150 of ECUs 114 via the gateway module 112, as discussed above. The process 300 continues in a block 375.

In the block 375, the vehicle computer 110 determines whether a third collective status of the ECUs 114 in the second set 150 of ECUs 114 is one of reinstalled or not reinstalled. The vehicle computer 110 determines the third collective status based on a third status message 250 from the gateway module 112, as discussed above. If the vehicle computer 110 determines that the third collective status is “reinstalled”, then the process 300 continues in a block 380. Otherwise, the vehicle computer 110 maintains the vehicle 105 in the safe mode, and the process 300 ends following the block 375.

In the block 380, the vehicle computer 110 transitions the safe mode to a disabled state. That is, the vehicle computer 110 can actuate one or more vehicle components to operate the vehicle 105. The process 300 ends following the block 380.

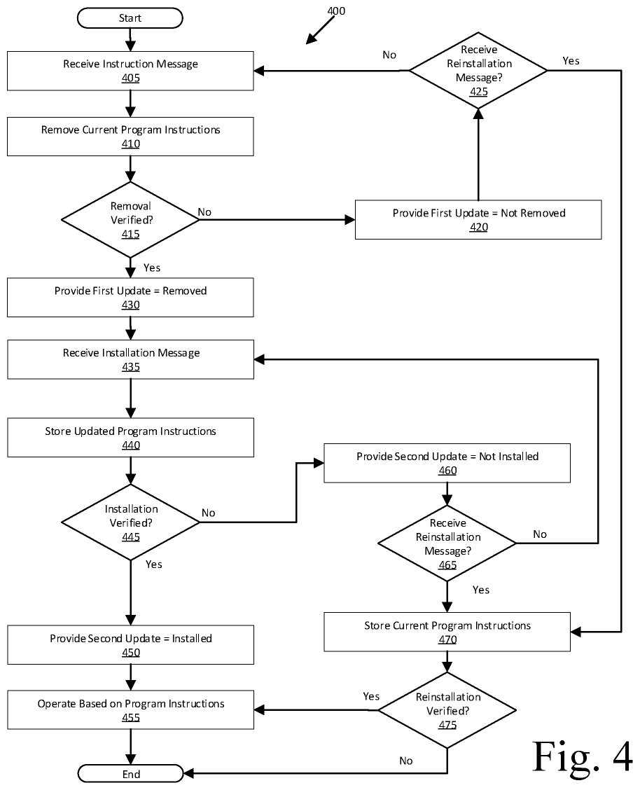

FIG. 4 is a diagram of an example process 400 executed in an ECU 114 according to program instructions stored in a memory thereof for updating program instructions in the ECU 114.

The process 400 begins in a block 405. In the block 405, the ECU 114 receives the instruction message 200 from the gateway module 112, as discussed above. The process 400 continues in a block 410.

In the block 410, the ECU 114 removes current program instructions from a memory. The process 300 continues in a block 415.

In the block 415, the ECU 114 verifies whether the current program instructions are removed from the memory. The ECU 114 can access a specified section of the memory to determine whether the specified section include or lacks data, as discussed above. If the ECU 114 verifies that the current program instructions are removed, the process 400 continues in a block 430. Otherwise, the process 400 continues in a block 420.

In the block 420, the ECU 114 provides a first update message 220 to the gateway module 112 indicating that the current program instructions are not removed from the memory of the ECU 114. The ECU 114 generates the first update message 220 based on detecting data stored in the specified section of the ECU 114's memory. Upon generating the first update message 220, the ECU 114 can transmit the first update message 220 to the gateway module 112, as discussed above. The process 400 continues in a block 425.

In the block 425, the ECU 114 determines whether a reinstallation message 210 is received. The ECU 114 can monitor the second communication network 107 to detect a received message. The ECU 114 can identify the reinstallation message 210 by accessing a header of the received message and determining a type of message specified by the header. If the ECU 114 receives a reinstallation message 210, the process 400 continues in a block 465. Otherwise, the process 400 returns to the block 405.

In the block 430, the ECU 114 provides a first update message 220 to the gateway module 112 indicating that the current program instructions are removed from the memory of the ECU 114. The block 430 is substantially the same as the block 420 of process 400, with the exception that the first update message 220 is generated based on detecting a lack of data stored in the specified section of the ECU 114's memory, and therefore will not be described further to avoid redundancy. The process 400 continues in a block 435.

In the block 435, the ECU 114 receives the installation message 205 from the gateway module 112, as discussed above. The process 400 continues in a block 410.

In the block 440, the ECU 114 stores the updated program instructions in the specified section of the memory. The ECU 114 can retrieve the updated program instructions from the installation message 205, as discussed above. The process 400 continues in a block 445.

In the block 445, the ECU 114 verifies whether the updated program instructions are stored in the memory. The block 445 is substantially the same as the block 415 of process 400 and therefore will not be described further to avoid redundancy. If the ECU 114 verifies that the updated program instructions are stored, the process 400 continues in a block 450. Otherwise, the process 400 continues in a block 460.

In the block 450, the ECU 114 provides a second update message 225 to the gateway module 112 indicating that the updated program instructions are stored in the memory of the ECU 114, as discussed above. The block 450 is substantially the same as the block 420 of process 400 and therefore will not be described further to avoid redundancy. The process 400 continues in a block 455.

In the block 455, the ECU 114 operates based on the program instructions stored in the specified section of the memory. The process 400 ends following the block 455.

In the block 460, the ECU 114 provides a second update message 225 to the gateway module 112 indicating that the updated program instructions are not stored in the memory of the ECU 114. The block 460 is substantially the same as the block 430 of process 400 and therefore will not be described further to avoid redundancy. The process 400 continues in a block 465.

In the block 465, the ECU 114 determines whether a reinstallation message 210 is received. The block 465 is substantially the same as the block 425 of process 400 and therefore will not be described further to avoid redundancy. If the ECU 114 receives a reinstallation message 210, the process 400 continues in a block 470. Otherwise, the process 400 returns to the block 435.

In the block 470, the ECU 114 stores the current program instructions in the specified section of the memory. The ECU 114 can retrieve the current program instructions from the reinstallation message 210, as discussed above. The process 400 continues in a block 475.

In the block 475, the ECU 114 verifies whether the current program instructions are stored in the memory. The block 475 is substantially the same as the block 415 of process 400 and therefore will not be described further to avoid redundancy. If the ECU 114 verifies that the current program instructions are stored, the process 400 continues in a block 455. Otherwise, the process 400 ends following the block 475.

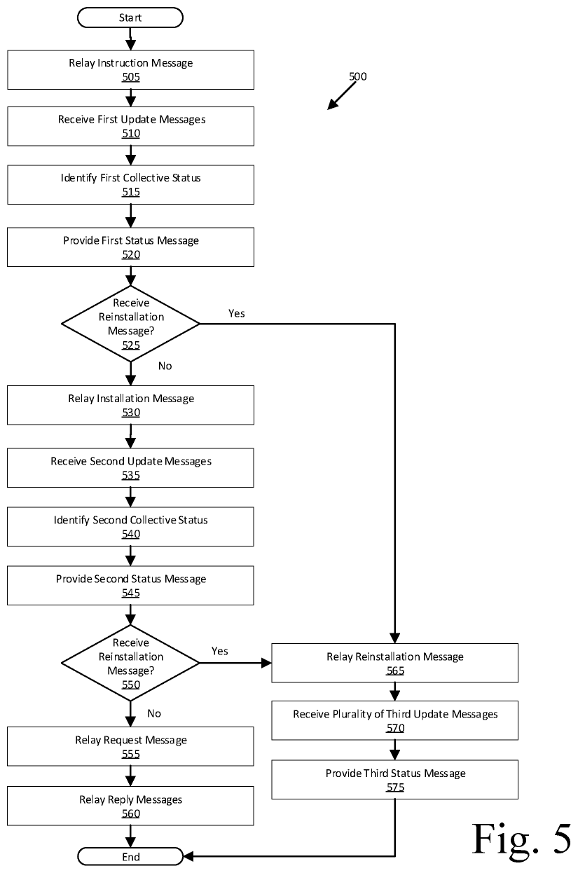

FIG. 5 is a diagram of an example process 500 executed in a gateway module 112 according to program instructions stored in a memory thereof for updating program instructions in a plurality of ECUs 114.

The process 500 begins in a block 505. In the block 505, the gateway module 112 relays the instruction message 200 from the vehicle computer 110 to the respective ECUs 114 in the second set 150 of ECUs 114, as discussed above. The process 500 continues in a block 510.

In the block 510, the gateway module 112 receives a plurality of first update messages 220 from the respective ECUs 114 in the second set 150 of ECUs 114, as discussed above. The process 500 continues in a block 515.

In the block 515, the gateway module 112 identifies a first collective status of the ECUs 114 in the second set 150 of ECUs 114 based on the plurality of first update message 220. The gateway module 112 determines the first collective status based on determining whether the current program instructions are removed from respective memories of the ECUs 114 in the second set 150 of ECUs 114, as discussed above. The process 500 continues in a block 520.

In the block 520, the gateway module 112 provides a first collective status to the vehicle computer 110. The gateway module 112 generates a first status message 240 based on the first collective status, as discussed above. Upon generating the first status message 240, the gateway module 112 can transmit the first stats message to the vehicle computer 110, as discussed above. The process 500 continues in a block 525.

In the block 525, the gateway module 112 determines whether a reinstallation message 210 is received. The block 525 is substantially the same as the block 425 of process 400 and therefore will not be described further to avoid redundancy. If the gateway module 112 receives a reinstallation message 210, the process 500 continues in a block 565. Otherwise, the process 500 returns to the block 530.

In the block 530, the gateway module 112 relays an installation message 205. The block 530 is substantially the same as the block 505 of process 500 and therefore will not be described further to avoid redundancy. The process 500 continues in a block 535.

In the block 535, receives a plurality of second update messages 225 from the respective ECUs 114 in the second set 150 of ECUs 114. The block 535 is substantially the same as the block 510 of process 500 and therefore will not be described further to avoid redundancy. The process 500 continues in a block 540.

In the block 540, the gateway module 112 identifies a second collective status of the ECUs 114 in the second set 150 of ECUs 114 based on the plurality of second update messages 225. The gateway module 112 determines the second collective status based on determining whether the updated program instructions are stored in respective memories of the ECUs 114 in the second set 150 of ECUs 114, as discussed above. The process 500 continues in a block 545.

In the block 545, the gateway module 112 provides a second collective status to the vehicle computer 110. The block 545 is substantially the same as the block 520 of process 500 and therefore will not be described further to avoid redundancy. The process 500 continues in a block 550.

In the block 550, the gateway module 112 determines whether a reinstallation message 210 is received. The block 550 is substantially the same as the block 425 of process 400 and therefore will not be described further to avoid redundancy. If the gateway module 112 receives a reinstallation message 210, the process 500 continues in a block 565. Otherwise, the process 500 returns to the block 555.

In the block 555, the gateway module 112 relays a request message 215. The block 555 is substantially the same as the block 505 of process 500 and therefore will not be described further to avoid redundancy. The process 500 continues in a block 560.

In the block 560, the gateway module 112 relays a reply message 235. The block 560 is substantially the same as the block 505 of process 500 and therefore will not be described further to avoid redundancy. The process 500 ends following the block 560.

In the block 565, the gateway module 112 relays a reinstallation message 210. The block 565 is substantially the same as the block 505 of process 500 and therefore will not be described further to avoid redundancy. The process 500 continues in a block 570.

In the block 570, receives a plurality of third update messages 230 from the respective ECUs 114 in the second set 150 of ECUs 114. The block 570 is substantially the same as the block 510 of process 500 and therefore will not be described further to avoid redundancy. The process 500 continues in a block 575.

In the block 575, the gateway module 112 provides a third collective status to the vehicle computer 110. The gateway module 112 determines the third collective status based on determining whether the current program instructions are stored in respective memories of the ECUs 114 in the second set 150 of ECUs 114, as discussed above. The process 500 continues in a block 575.

As used herein, the adverb “substantially” means that a shape, structure, measurement, quantity, time, etc. may deviate from an exact described geometry, distance, measurement, quantity, time, etc., because of imperfections in materials, machining, manufacturing, transmission of data, computational speed, etc.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board first computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A system, comprising:
a computer;
a plurality of electronic control units (ECUs); and
a gateway module in communication with the computer and in communication with the plurality of ECUs;
wherein the computer is programmed to:
upon receiving updated program instructions, provide an instruction, via the gateway module, to respective ones of the ECUs to remove current program instructions from respective memories of the ECUs;
upon receiving in response to the instruction a message from the gateway module indicating that the current program instructions are removed from the ECUs' respective memories, provide the updated program instructions, via the gateway module, to the ECUs; and
upon receiving a message from the gateway module indicating that the updated program instructions are not stored in the respective memory of at least one of the ECUs, provide the updated program instructions, via the gateway module, based on a number of received messages indicating that the updated program instructions are not stored in the respective memory of at least one of the ECUs being less than a threshold.

2. The system of claim 1, wherein the computer is further programmed to, upon determining the number of received messages indicating that the updated program instructions are not stored in the respective memory of at least one of the ECUs is equal to the threshold, provide the current program instructions and an instruction to store the current program instructions.

3. The system of claim 2, wherein the computer is further programmed to, upon receiving a message from the gateway module indicating that the current program instructions are not stored in the respective memory of at least one ECU, prevent vehicle operation.

4. The system of claim 1, wherein the computer is further programmed to, upon receiving a message from the gateway module indicating that the current program instructions are not removed from at least one of the memories in response to the instruction, provide the instruction based on a number of received messages being less than the threshold.

5. The system of claim 4, wherein the computer is further programmed to, upon determining the number of received messages is equal to the threshold, provide the current program instructions and an instruction to store the current program instructions.

6. The system of claim 5, wherein the computer is further programmed to, upon receiving a message from the gateway module indicating that the current program instructions are not stored in the respective memory of at least one of the ECUs, prevent vehicle operation.

7. The system of claim 4, wherein the computer is further programmed to:
increment a counter in response to receiving one of the message indicating that the current program instructions are not removed from at least one of the memories or the message indicating that the updated program instructions are not stored in the respective memory of at least one of the ECUs; and
upon determining the counter is equal to the threshold, provide, via the gateway module, the current program instructions and an instruction to store the current program instructions to the ECUs.

8. The system of claim 7, wherein the computer is further programmed to, upon receiving a message from the gateway module indicating that the current program instructions are not stored in the respective memory of at least one of the ECUs, prevent vehicle operation.

9. The system of claim 1, wherein the ECUs are programmed to:
upon determining that the current program instructions are removed in response to the instruction, transmit a message to the gateway module indicating the current program instructions are removed; and
upon determining that the current program instructions are not removed in response to the instruction, transmit a message to the gateway module indicating the current program instructions are not removed.

10. The system of claim 9, wherein the gateway module is programmed to:
identify a collective status of the ECUs that is one of removed or not removed based on whether the gateway module receives, from at least one of the ECUs, the message indicating the current program instructions are not removed; and
provide one of the message indicating that the current program instructions are removed from the ECUs' respective memories or the message indicating that the current program instructions are not removed from at least one of the memories to the computer based on the identified collective status.

11. The system of claim 1, wherein the ECUs are programmed to:
upon determining that the updated program instructions are stored in the respective memory in response to receiving the updated program instructions, transmit a message to the gateway module indicating that the updated program instructions are stored; and
upon determining that the updated program instructions are not stored in the respective memory in response to receiving the updated program instructions, transmit a message to the gateway module indicating that the updated program instructions are not stored.

12. The system of claim 11, wherein the gateway module is programmed to:
identify a collective status of the ECUs that is one of installed or not installed based on whether the gateway module receives, from at least one of the ECUs, the message indicating the updated program instructions are not stored; and
provide one of the message indicating that the updated program instructions are not stored in the respective memory of at least one of the ECUs or a message indicating that the updated program instructions are stored in the ECUs' respective memories to the computer based on the identified collective status.

13. A method, comprising:
upon receiving, at a computer, updated program instructions, providing an instruction, via a gateway module, to respective ones of a plurality of ECUs to remove current program instructions from respective memories of the ECUs;
upon receiving, at the computer, in response to the instruction a message from the gateway module indicating that the current program instructions are removed from the ECUs' respective memories, providing the updated program instructions, via the gateway module, to the ECUs; and
upon receiving, at the computer, a message from the gateway module indicating that the updated program instructions are not stored in the respective memory of at least one of the ECUs, providing the updated program instructions, via the gateway module, based on a number of received messages indicating that the updated program instructions are not stored in the respective memory of at least one of the ECUs being less than a threshold.

14. The method of claim 13, further comprising, upon receiving, at the computer, a message from the gateway module indicating that the current program instructions are not removed from at least one of the memories in response to the instruction, providing the instruction based on a number of received messages indicating that the current program instructions are not removed from at least one of the memories being less than the threshold.

15. The method of claim 14, further comprising:
incrementing a counter in response to receiving one of the message indicating that the current program instructions are not removed from at least one of the memories or the message indicating that the updated program instructions are not stored in the respective memory of at least one of the ECUs; and
upon determining the counter is equal to the threshold, providing, via the gateway module, the current program instructions and an instruction to store the current program instructions to the ECUs.

16. The method of claim 15, further comprising, upon receiving a message from the gateway module indicating that the current program instructions are not stored in the respective memory of at least one of the ECUs, preventing vehicle operation.

17. The method of claim 13, further comprising:
upon determining, at the ECUs, that the current program instructions are removed in response to the instruction, transmitting a message to the gateway module indicating the current program instructions are removed; and
upon determining that the current program instructions are not removed in response to the instruction, transmitting a message to the gateway module indicating the current program instructions are not removed.

18. The method of claim 17, further comprising:
identifying, at the gateway module, a collective status of the ECUs that is one of removed or not removed based on whether the gateway module receives, from at least one of the ECUs, the message indicating the current program instructions are not removed; and
providing one of the message indicating that the current program instructions are removed from the ECUs' respective memories or the message indicating that the current program instructions are not removed from at least one of the memories to the computer based on the identified collective status.

19. The method of claim 13, further comprising:
upon determining, at the ECUs, that the updated program instructions are stored in the respective memory in response to receiving the updated program instructions, transmitting a message to the gateway module indicating that the updated program instructions are stored; and
upon determining that the updated program instructions are not stored in the respective memory in response to receiving the updated program instructions, transmitting a message to the gateway module indicating that the updated program instructions are not stored.

20. The method of claim 19, further comprising:
identifying, at the gateway module, a collective status of the ECUs that is one of installed or not installed based on whether the gateway module receives, from at least one of the ECUs, the message indicating the updated program instructions are not stored; and
providing one of the message indicating that the updated program instructions are not stored in the respective memory of at least one of the ECUs or a message indicating that the updated program instructions are stored in the ECUs' respective memories to the computer based on the identified collective status.
